(19) United States
(12) Patent Application Publication
(10) Pub. No.: US 2007/0093407 A1
(43) Pub. Date: Apr. 26, 2007

(54) Process of treating fabrics

(75) Inventors: Giulia Ottavia Bianchetti, Rome (IT); Leo Gagliardi, Rome (IT); Giovanni Grande, Rome (IT); Luca Scarcinelli, Cerveteri (Rome) (IT)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/546,226

(22) Filed: Oct. 11, 2006

(30) Foreign Application Priority Data
Oct. 26, 2005 (EP) 05 110 015.4

(51) Int. Cl. C11D 3/37

(52) U.S. Cl. 510/499

(57) ABSTRACT

According to the present invention there is provided a process of treating a fabric with a laundry pretreater composition comprising a peroxycarboxylic acid. More specifically, the process of the present invention comprises the step of mechanically rubbing the laundry pretreater composition into stained parts of a fabric.

### TECHNICAL FIELD

The present invention relates to bleaching compositions. More specifically, the present invention is directed to a process of treating a fabric with a composition comprising a peroxycarboxylic acid.

### BACKGROUND OF THE INVENTION

The cleaning of stains known as “bleachable” stains, such as those caused by red wine, coffee, tea or fruit juices, from fabrics, has always constituted a challenge. Due to the presence of chromophores in the stains, the highly coloured bleachable stains require the use of bleaching additives, either alone or in combination with regular laundry detergents. Commonly encountered bleaching compositions suitable for the bleaching of stains on fabrics and hard-surfaces are based on halogen bleaches, especially hypochlorite bleaches. Halogen bleaches which are extremely effective bleaching agents, are however relatively aggressive to fabrics and may cause damages such as loss of tensile strength or loss of colour intensity of the fabric. While colour and fabric damage may be minimised by employing milder oxygen bleaches such as hydrogen peroxide, the bleach performance characteristics of such peroxygen bleaches are much less desirable than those of the halogen bleaching agents.

Faced with achieving a balance between cleaning performance and fabric and/or colour damage, bleaching compositions comprising peroxy carboxylic acids as bleaching agents, have been developed. Such bleaching agents are less aggressive bleach than hypochlorite, yet still provide improved cleaning performance versus the peroxygen bleaching agents currently used in most fully formulated detergent compositions. Liquid additives comprising peroxy carboxylic acid may be either directly applied on stains and soiled fabrics before washing (as a pretreating agent) or added into the laundry machine or laundry solution.

However, despite the apparent suitability of those bleaching agents, it has been found that cleaning performance is occasionally not sufficient to meet consumer expectations, in particular when it relates to removing so-called hydrophilic bleachable stains (such as tea, wine, coffee) and mixed greasy/bleachable stains (such as bacon grease, burnt butter, etc.). This problem is particularly acute when the bleaching agent used is solid and substantially water-insoluble.

It is therefore an object of the present invention to address the issues mentioned above, namely those of providing improved overall stain removal performance on a wide range of soils, in particular mixed greasy/bleachable stains, in addition to providing colour and fabric safety.

We have found that these issues are efficiently addressed when a fabric is treated using the particular process of bleaching fabrics of the present invention. Indeed, it has been found that when fabrics are treated using a process involving the step of mechanically rubbing the bleaching composition into the treated fabric, improved bleaching performance as well as improved overall stain removal performance is delivered to the fabrics. It has surprisingly been found that by using this process of treating fabrics, improved stain removal and in particular significantly improved mixed greasy/bleachable stain removal can be achieved as compared to the performance delivered with a conventional fully formulated detergent composition comprising the same bleaching agent. Furthermore, it has also been found that when using the process described herein fabric and/or colour damage is minimal.

Further advantages and more specific properties of the process of the present invention, will become clear after reading the following description of the invention.

### SUMMARY OF THE INVENTION

In a first embodiment, the present invention relates to a process of treating a fabric comprising the separate steps of:
(a) applying a laundry pretreater composition comprising a peroxy carboxylic acid onto stained parts of a fabric; thereafter
(b) mechanically rubbing said composition into said stained parts of fabric; and subsequently
(c) rinsing said fabric in an aqueous bath and/or washing said fabric in an aqueous wash liquor comprising water and a conventional laundry detergent.

In an another embodiment of the present invention, it is provided a kit of parts comprising: (a) a laundry pretreater composition comprising a peroxycarboxylic acid; (b) instructions for treating fabrics according to the above process of claim 1, and optionally, (c) an implement suitable for use in the above process.

### DETAILED DESCRIPTION

The present invention encompasses a process of treating fabrics as described herein after.

By “fabric”, it is to be understood any type of fabric including for example natural and synthetic fabrics and these used to make clothes, curtains, drapes, bed linens, bath linens, table cloths, sleeping bags, tents, upholstered furniture and the like. By “natural” fabrics, it is meant fabrics made of cotton, viscose, linene, silk and/or wood. By “synthetic” fabrics, it is meant those made of synthetic fibers like polymeric fibers (polyamide, polyester, lycra® and elasthane®), and those made of both natural and synthetic fibers.

By “treating a fabric”, it is meant herein bleaching and/or disinfecting said fabric and cleaning, i.e. removing various types of stains form the fabric.

By “pretreater composition”, it is meant that the corresponding composition is applied to the fabric prior to rinsing the fabric in an aqueous bath and/or washing the fabric in an aqueous wash liquor.

By “substantially water-insoluble compound”, it is to be understood a compound having a water solubility of 0.5% w/w and below, in distilled water at 20° C.

Process

The process of the present invention requires that in one step (a) a laundry pretreater composition is applied onto stained parts of a fabric, in a second subsequent step (b), the composition is mechanically agitated into stained parts of the fabric and in a third subsequent step (c), the fabric is rinsed in an aqueous bath and/or washed in an aqueous wash liquor comprising water and a conventional laundry detergent. All the steps (a), (b) and (c), are performed subsequently and in that specific order.

All the steps of the process may be performed by hand, but in a preferred embodiment of the present invention and for the convenience of the user, step (c) of the process is carried out in a laundry washing machine having at least one rinse cycle and a wash cycle. In general, washing machines have a pre-rinse cycle wherein the fabric is moistening with at least water. This pre-rinse cycle may be followed by additional rinse cycles, but is normally followed with the main wash cycle. It is into the main wash cycle that detergent compositions are conventionally delivered. The main wash cycle is followed with at least one post-wash rinse cycle, preferably at least 2 rinse cycles. It is preferred that step (c) is performed in the pre-rinse and/or in the main wash cycle.

The process of treating a fabric according to the present invention is performed in a so-called “pretreatment mode”, i.e. the pretreater composition, as defined herein, is applied neat onto stained parts of said fabric before the fabric is rinsed, or washed then rinsed. In a highly preferred embodiment, the fabric so treated is rinsed after it has been contacted with said composition, before said composition has completely dried off.

The compositions used in the process of the present invention are preferably contacted to fabrics in a liquid form. Indeed, by “liquid form”, it is meant herein that the liquid compositions are contacted in neat form, in their diluted form or in their dissolved form.

In the process of treating a fabric according to the present invention the laundry pretreater composition remains in contact with the stained parts of the fabric for a period of time sufficient to bleach the fabric. When used in diluted form the acidic liquid aqueous composition herein remains in contact with the fabrics for up to 24 hours, preferably from 1 minute to 12 hours and more preferably from 20 minutes to 6 hours. When used in its neat form the acidic liquid aqueous composition herein remains in contact with the fabrics for up to 24 hours, preferably from 1 minute to 2 hours and more preferably from 1 minute to 1 hour.

The temperature of the bleaching process has an influence on the stain removal performance and/or bleaching performance of the bleaching compositions. More specifically, an increased temperature accelerates the bleaching process, i.e. diminishes the time required to bleach a given soil. It is therefore preferred that step (a) of the treating process according to the present invention, where the preatreater composition as described herein is used in its diluted, is performed of a temperature of from 4° C. to 60° C., preferably from 10° C. to 50° C. and most preferably from 20° C. to 40° C.

The process of treating a fabric according to the present invention further comprises as an essential step, the step of mechanically rubbing the laundry pretreater composition into the stained parts of the fabric.

In a preferred embodiment, the step of mechanically rubbing the composition is performed using an implement.

The mechanical rubbing may be performed by rubbing said implement in a circular motion vis-à-vis stained parts of the fabric to be treated. Alternatively, the mechanical rubbing step may be operated by rubbing the implement in a back and forth transversal motion with respect to stained of the fabric.

Suitable implements may be for instance selected from the group of brushes, wipes, sponges, dosing balls having a pretreater outlet and fingers. In a highly preferred execution of the invention, the implement is selected to be a brush. Preferably, the implement is made from a material which is not capable of absorbing the laundry pretreater composition.

It has now been surprisingly discovered that a process of treating a fabric according to the present invention, i.e. comprising the step of mechanically rubbing said laundry pretreater composition into stained parts of the treated fabric, provides improved bleaching performance, as well as improved overall stain removal performance, in particular on mixed greasy/bleachable stains as compared to the performance delivered with a similar process but without the additional mechanical rubbing step. Examples of bleachable stains are those provoked by coloured fruits, tea, coffee or red wine. Mixed greasy/bleachable stains are for example lipstick, burnt butter.

In the context of the present invention, such a remarkable performance is due to a highly and unexpected synergetic effect between the peroxycarboxylic acid-containing pretreater composition and the implement. It has been indeed surprisingly found that when comparing the cleaning performance of a regular peroxide-based pretreater composition with a similar peroxycarboxylic acid-based pretreater, both tested with and without brushing, a significantly improved performance of mixed greasy/bleachable stains removal is observed for the peroxycarboxylic acid-containing pretreater composition applied using the implement, whereas the peroxide-based pretreater only shows an insignificant improvement. Similarly, the cleaning performance on greasy and bleachable stains by the peroxycarboxylic acid-containing pretreater composition is also improved due to the mechanical rubbing and when compared to the peroxide-based pretreater composition.

Without whishing to be bound by theory, it is believed that the improved stain removal performance of the peroxycarboxylic acid-containing pretreater composition used together with the step of mechanically rubbing said composition as compared to the same pretreater composition without the mechanical rubbing step, is based on the fact that the peroxycarboxylic acid, which is preferably in a water-insoluble solid state, does not easily penetrate within the fabric fibers. As a detrimental consequence, the solid peracid is rapidly washed away from the stain before it actually gets solubilized at and thus activated in the subsequent washing/rinsing step. By mechanically rubbing the peroxycarboxylic acid-containing pretreater composition into stained parts of the fabric, it is believed that the penetration of said peroxycarboxylic acid within the stained fibers is facilitated as said compound is brought into intimate and prolonged contact with the stains to be removed.

The process of treating a fabric according to the present invention comprises as a further essential step, the step of rinsing said fabric in an aqueous bath and/or washing said fabric in an aqueous wash liquor comprising water and a conventional laundry detergent. In a preferred embodiment, the process comprises both the step of rinsing said fabric and the step of washing said fabric. When both step the rinsing step and the washing step are performed, it is preferred to perform the rinsing step herein after said fabric has been washed with a conventional laundry detergent composition. This can either be performed by hand in a container of water or by placing the fabric under flowing water or in a rinse cycle and/or in the main wash cycle of a laundry washing machine.

Laundry Pretreater Composition

The process of the present invention requires contacting a fabric with a laundry pretreater composition comprising a peroxy carboxylic acid (hereafter referred to as peracid). Suitable peracids are any of those known in the art. Preferred peracids are those having general formula: 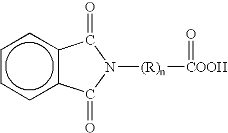
wherein R is selected from C1-4 alkyl and n is an integer of from 1 to 5.

In a particularly preferred aspect of the present invention the peracid has the formula such that R is CH₂ and n is 5 i.e. phthaloyl amino-peroxy caproic acid or PAP.

The peracid is preferably used as a substantially water-insoluble solid compound and is available from Ausimont under the tradename Euroco®.

The peracid is present may be present at a level in the composition of from 0.1% to 10% more preferably 0.5% to 8% and most preferably 1% to 6%. Alternatively the peracid may be present at a much higher level of for example 10% to 40%, more preferably from 15% to 30%, most preferably from 20% to 25%.

The laundry pretreater composition may be in granular, but is preferably in liquid form. The term liquid is to be understood as including gel-like or pasty form as well. Where the laundry pretreater composition is liquid, it is preferably aqueous, comprising water at a level of preferably 10 to 99%, more preferably from 50% to 98% by weight of the bleaching composition.

In another preferred execution, the laundry pretreater composition is in pasty form. According to this preferred embodiment, it is particularly preferred that the composition has a viscosity of from 200 cps to 10000 cps, preferably from 500 to 5000 cps, more preferably from 1000 to 3000 cps, most preferably from 1000 to 2000 cps, at 20 sec⁻¹ and 20° C., when measured with a Carry-Med Rheometer model CSL² 100® (supplied by TA Instruments) with a 4 cm conic spindle in stainless steal (linear increment from 0.1 to 100 sec⁻¹ in max. 8 minutes).

The bleaching composition may comprise other components in addition to the peracid. Examples of such components are described herein as optional ingredients.

Preferred optional components include surfactants, preferably anionic surfactants. In this embodiment it is also particularly preferred that the surfactant be present at a level of less than 5%.

Another particularly preferred component is a suspending agent. Suspending agents are components that aid or facilitate the suspension of insoluble or partially insoluble solids in a liquid environment. The peracids currently available are generally solid and substantially water insoluble. If solid particles are incorporated in a liquid composition, the particles fall to the bottom of the container holding the liquid. A way of uniformly distributing the solid (e.g. peracid) throughout the liquid composition is to incorporate suspending agent. In the present invention preferred suspending agents are polymers for example natural-gum polymers (e.g. xanthan gum), cross-linked polycarboxylic acids, polyvinyl polymers (PVA, PVP etc). Preferably the suspending agent of the present invention is selected from xanthan gum, cross-linked polycarboxylic acid and mixtures thereof.

The laundry pretreater composition is preferably acidic i.e. the laundry pretreater composition preferably has a pH of less than 7, more preferably from 1 to 8.5, most preferably from 3 to 4.

By “diluted form”, it is meant herein that the composition as described hereinafter, may be diluted by the user, preferably with water. Such dilution may occur for instance in hand laundry applications as well as by the other means such as in washing machine. Said compositions can be diluted up to 500 times, preferably from 5 to 200 times and more preferably from 10 to 80 times. In a preferred embodiment herein said composition is used in its diluted form.

By “dissolved form”, it is meant herein that the composition as described hereinafter may be dissolved by the user in a suitable solvent, preferably selected from the group of alkaline water solution, organic solvents, and mixtures thereof. Suitable solvents for use herein may be preferably selected from the group of alcohols, alkoxylated alcohols, ketones, esters, carboxylic acids, salt of carboxylic acids, sulfonic acids, salt of sulfonic acids, ethers, and mixtures thereof.

An advantage of the laundry pretreater compositions, suitable for use in the process of treating fabrics according to the present invention, is that they are physically and chemically stable upon prolonged periods of storage.

Chemical stability of these compositions may be evaluated by measuring the concentration of available oxygen at given storage time after having manufactured the compositions. By “chemically stable” it is meant herein that the compositions used herein comprising a peracid do not undergo more than 15% AvO loss, in one month at 25° C. and preferably not more than 10%.

Available oxygen (AvO) loss of a peracid-containing composition can be measured by titration with potassium permanganate after reduction with a solution containing ammonium ferrous sulphate. Said stability test method is well known in the art and is reported, for example, on the technical information sheet of Curox® commercially available from Interox. Alternatively peracid concentration can also be measured using a chromatography method described in the literature for peracids (F. Di Furia et al., Gas-liquid Chromatography Method for Determination of Peracids, Analyst, Vol 113, May 1988, p 793-795).

By “physically stable” it is meant herein that no phase separation occurs in the bleaching composition used herein for a period of 7 days at 50° C.

Detergent Composition

The process of the present invention requires contacting a fabric with a detergent composition. By the term detergent composition it is understood fully formulated detergent compositions currently available on the market. These compositions are those that are generally expected to be used in the wash cycle of a laundry washing machine. The detergent composition comprises conventional detergent ingredients.

Suitable conventional detergent ingredients for use in such detergent compositions are described for example in co-pending patent applications UK 96/16112.0, UK 97/13946.3, or WO 96/28531 and or EP-B-707626. Such conventional detergent compositions may be commonly know under the tradenames Ariel®, Dash®, Tide®, Omo® or Dixan®.

Such liquid detergent and/or granular detergent compositions may also comprise at least one or more other conventional detergent ingredients, preferably selected from builders (up to 80%), organic polymeric compounds (up to 20%), bleaching agents (up to 25%), bleach activators (up to 15%) , enzymes (typically 0.0001% to 2%), suds suppressers (up to 4%), dispersants (up to 15%), lime-soap dispersants (up to 15%), soil suspending agents (up to 20%), antiredepositions agents (up to 20%), corrosion inhibitors (up to 10%), solvents (up to 20%), chelating agents (up to 15%), dyes, pigments, perfumes and the like. The precise nature of the additional conventional detergent ingredients and levels of incorporation thereof will depend on the physical form of the detergent composition and the end characteristics of the composition desired.

The detergent composition of the present invention does not comprise a peracid, although it may comprise another mild bleach or bleach system such as a bleach precursor and a bleach activator.

The detergent composition may be in granular or liquid form. Preferably, the detergent composition comprises surfactant and where present the surfactant is present at a level of greater than 5%.

The detergent composition when in liquid form or a 1% solution thereof when in granular form preferably has a pH of greater than 7, more preferably greater than 9, most preferably in the range of from 9 to 11.5. The pH of both the bleaching and detergent compositions may be adjusted using any acidic or alkaline agent known to those skilled in the art. Examples of acidic agents are organic acids such as citric acid and inorganic acids such as sulphuric acid, sulphonic acid and/or methane sulphonic acid. Examples of alkaline agents are sodium hydroxide, potassium hydroxide and/or sodium carbonate.

Typically, such liquid detergent compositions and/or granular detergent compositions may be diluted up to 250 times their weight of water to provide an alkaline solution as described herein, preferably from 2 to 200 and more preferably from 10 to 160. Such dilution may occur for instance in hand laundry application as well as by other means such as in washing machine.

Optional Ingredients

The laundry pretreater compositions used in the process of treating a fabric according to the present invention may comprise a variety of optional ingredients such as surfactants, chelating agents, radical scavengers, antioxidants, stabilisers, builders, soil suspending polymers, polymeric soil release agents, dye transfer agents, solvents, suds controlling agents, brighteners, perfumes, pigments, dyes and the like.

Preferred optional ingredients which may be incorporated into the laundry pretreater compositions for use in the process according to the present invention, may be selected from the group of surfactants, soil suspending polymers and polymeric soil release agents, and mixtures thereof.

Surfactants

The compositions of the present invention may comprise a surfactant or a mixture thereof including nonionic surfactants, anionic surfactants, cationic surfactants, zwitterionic surfactants and/or amphoteric surfactants.

Typically, the compositions according to the present invention may comprise from 0.01% to 50% by weight of the total composition of a surfactant or a mixture thereof, preferably from 0.1% to 30% and more preferably from 0.2% to 10%.

Suitable anionic surfactants for use in the compositions herein include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂-₁₆ are preferred for lower wash temperatures (e.g., below about 50° C.) and C₁₆-₁₈ alkyl chains are preferred for higher wash temperatures (e.g., above about 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate, C₁₂-C₁₈E(1.0)M), C₁₂-C₁₈ alkyl polyethoxylate (2.25) sulfate, C₁₂-C₁₈E(2.25)M), C₁₂-C₁₈ alkyl polyethoxylate (3.0) sulfate C₁₂-C₁₈E(3.0), and C₁₂-C₁₈ alkyl polyethoxylate (4.0) sulfate C₁₂-C₁₈E(4.0)M), wherein M is conveniently selected from sodium and potassium.

Other particularly suitable anionic surfactants for use herein are alkyl sulphonates including water-soluble salts or acids of the formula RSO₃M wherein R is a C₆-C₂₂ linear or branched, saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₂ linear or branched saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium, calcium, magnesium etc) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

The alkylsulfonates and alkyl aryl sulphonates for use herein include primary and secondary alkylsulfonates and primary and secondary alkyl aryl sulphonates. By “secondary C6-C22 alkyl or C6-C22 alkyl aryl sulphonates”, it is meant herein that in the formula as defined above, the SO3M or aryl-SO3M group is linked to a carbon atom of the alkyl chain being placed between two other carbons of the said alkyl chain (secondary carbon atom).

For example C14-C16 alkyl sulphonate salt is commercially available under the name Hostapur® SAS from Hoechst and C8-alkylsulphonate sodium salt is commercially available under the name Witconate NAS 8® from Witco SA. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright & Wilson.

Other anionic surfactants useful for detersive purposes can also be used herein. These can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄-₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO—M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23.

Other particularly suitable anionic surfactants for use herein are alkyl carboxylates and alkyl alkoxycarboxylates having from 4 to 24 carbon atoms in the alkyl chain, preferably from 8 to 18 and more preferably from 8 to 16, wherein the alkoxy is propoxy and/or ethoxy and preferably is ethoxy at an alkoxylation degree of from 0.5 to 20, preferably from 5 to 15. Preferred alkylalkoxycarboxylate for use herein is sodium laureth 11 carboxylate (i.e., RO(C₂H₄O)₁₀—CH₂COONa, with R═C12-C14) commercially available under the name Akyposoft® 100NV from Kao Chemical Gbmh.

Suitable amphoteric surfactants for use herein include amine oxides having the following formula R₁R₂R₃NO wherein each of R1, R2 and R3 is independently a saturated substituted or unsubstituted, linear or branched hydrocarbon chain of from 1 to 30 carbon atoms. Preferred amine oxide surfactants to be used according to the present invention are amine oxides having the following formula R₁R₂R₃NO wherein R1 is an hydrocarbon chain comprising from 1 to 30 carbon atoms, preferably from 6 to 20, more preferably from 8 to 16, most preferably from 8 to 12, and wherein R2 and R3 are independently substituted or unsubstituted, linear or branched hydrocarbon chains comprising from 1 to 4 carbon atoms, preferably from 1 to 3 carbon atoms, and more preferably are methyl groups. R1 may be a saturated, substituted or unsubstituted linear or branched hydrocarbon chain. Suitable amine oxides for use herein are for instance natural blend C8-C10 amine oxides as well as C12-C16 amine oxides commercially available from Hoechst.

Suitable zwitterionic surfactants for use herein contain both a cationic hydrophilic group, i.e., a quaternary ammonium group, and anionic hydrophilic group on the same molecule at a relatively wide range of pH's. The typical anionic hydrophilic groups are carboxylates and sulfonates, although other groups like sulfates, phosphonates, and the like can be used. A generic formula for the zwitterionic surfactants to be used herein is:
R₁−N⁺(R₂)(R₃)R₄X⁻

wherein R₁ is a hydrophobic group; R₂ is hydrogen, C₁-C₆ alkyl, hydroxy alkyl or other substituted C₁-C₆ alkyl group; R₃ is C₁-C₆ alkyl, hydroxy alkyl or other substituted C₁-C₆ alkyl group which can also be joined to R₂ to form ring structures with the N, or a C₁-C₆ carboxylic acid group or a C₁-C₆ sulfonate group; R₄ is a moiety joining the cationic nitrogen atom to the hydrophilic group and is typically an alkylene, hydroxy alkylene, or polyalkoxy group containing from 1 to 10 carbon atoms; and X is the hydrophilic group which is a carboxylate or sulfonate group.

Preferred hydrophobic groups R₁ are aliphatic or aromatic, saturated or unsaturated, substituted or unsubstituted hydrocarbon chains that can contain linking groups such as amido groups, ester groups. More preferred R₁ is an alkyl group containing from 1 to 24 carbon atoms, preferably from 8 to 18, and more preferably from 10 to 16. These simple alkyl groups are preferred for cost and stability reasons. However, the hydrophobic group R₁ can also be an amido radical of the formula Rₐ—C(O)—NH—(C(R_{b})₂)ₘ, wherein Rₐ is an aliphatic or aromatic, saturated or unsaturated, substituted or unsubstituted hydrocarbon chain, preferably an alkyl group containing from 8 up to 20 carbon atoms, preferably up to 18, more preferably up to 16, R_{b} is selected from the group consisting of hydrogen and hydroxy groups, and m is from 1 to 4, preferably from 2 to 3, more preferably 3, with no more than one hydroxy group in any (C(R_{b})₂) moiety.

Preferred R₂ is hydrogen, or a C₁-C₃ alkyl and more preferably methyl. Preferred R₃ is a C₁-C₄ carboxylic acid group or C1-C4 sulfonate group, or a C₁-C₃ alkyl and more preferably methyl. Preferred R₄ is (CH2)ₙ wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082.

Examples of particularly suitable alkyldimethyl betaines include coconut-dimethyl betaine, lauryl dimethyl betaine, decyl dimethyl betaine, 2-(N-decyl-N, N-dimethyl-ammonia)acetate, 2-(N-coco N, N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C10-C14 fatty acylamidopropylene(hydropropylene)sulfobetaine. For example C10-C14 fatty acylamidopropylene(hydropropylene)sulfobetaine is commercially available from Sherex Company under the trade name “Varion CAS® sulfobetaine”.

A further example of betaine is Lauryl-immino-dipropionate commercially available from Rhone-Poulenc under the trade name Mirataine H2C-HA®.

Suitable cationic surfactants for use herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups. Preferred quaternary ammonium compounds suitable for use herein are non-chloride/non halogen quaternary ammonium compounds. The counterion used in said quaternary ammonium compounds are compatible with any persulfate salt and are selected from the group of methyl sulfate, or methylsulfonate, and the like.

Particularly preferred for use in the compositions of the present invention are trimethyl quaternary ammonium compounds like myristyl trimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

Amongst the nonionic surfactants, alkoxylated nonionic surfactants and especially ethoxylated nonionic surfactants are suitable for use herein. Particularly preferred nonionic surfactants for use herein are the capped alkoxylated nonionic surfactants.

Suitable capped alkoxylated nonionic surfactants for use herein are according to the formula:
R₁(O—CH₂-CH₂)ₙ-(OR₂)ₘ—O—R₃

wherein R₁ is a C₈-C₂₄ linear or branched alkyl or alkenyl group, aryl group, alkaryl group, preferably R₁ is a C₈-C₁₈ alkyl or alkenyl group, more preferably a C₁₀-C₁₅ alkyl or alkenyl group, even more preferably a C₁₀-C₁₅ alkyl group;

wherein R₂ is a C₁-C₁₀ linear or branched alkyl group, preferably a C₂-C₁₀ linear or branched alkyl group;

wherein R₃ is a C₁-C₁₀ alkyl or alkenyl group, preferably a C₁-C₅ alkyl group, more preferably methyl;

and wherein n and m are integers independently ranging in the range of from 1 to 20, preferably from 1 to 10, more preferably from 1 to 5; or mixtures thereof.

These surfactants are commercially available from BASF under the trade name Plurafac®, from HOECHST under the trade name Genapol® or from ICI under the trade name Symperonic®. Preferred capped nonionic alkoxylated surfactants of the above formula are those commercially available under the tradename Genapol® L 2.5 NR from Hoechst, and Plurafac® from BASF.

Soil Suspending Polymers and Polymeric Soil Release Agents

The compositions according to the present invention may further comprise a soil suspending polyamine polymer or mixtures thereof, as optional ingredient. Any soil suspending polyamine polymer known to those skilled in the art may be used herein. Particularly suitable polyamine polymers for use herein are polyalkoxylated polyamines. Such materials can conveniently be represented as molecules of the empirical structures with repeating units:

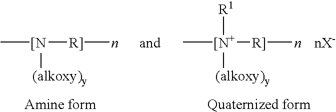

wherein R is a hydrocarbyl group, usually of 2-6 carbon atoms; R¹ may be a C₁-C₂₀ hydrocarbon; the alkoxy groups are ethoxy, propoxy, and the like, and y is 2-30, most preferably from 10-20; n is an integer of at least 2, preferably from 2-20, most preferably 3-5; and X⁻is an anion such as halide or methylsulfate, resulting from the quaternization reaction.

The most highly preferred polyamines for use herein are the so-called ethoxylated polyethylene amines, i.e., the polymerized reaction product of ethylene oxide with ethyleneimine, having the general formula:

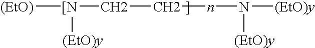

when y=2−30. Particularly preferred for use herein is an ethoxylated polyethylene amine, in particular ethoxylated tetraethylenepentamine, and quaternized ethoxylated hexamethylene diamine.

Soil suspending polyamine polymers contribute to the benefits of the present invention, i.e., that when added on top of said diacyl peroxide, further improve the stain removal performance of a composition comprising them, especially under laundry pretreatment conditions, as described herein. Indeed, they allow improving the stain removal performance on a variety of stains including greasy stains, enzymatic stains, clay/mud stains as well as on bleachable stains.

Typically, the compositions comprise up to 10% by weight of the total composition of such a soil suspending polyamine polymer or mixtures thereof, preferably from 0.1% to 5% and more preferably from 0.3% to 2%.

The compositions herein may also comprise other polymeric soil release agents known to those skilled in the art. Such polymeric soil release agents are characterized by having both hydrophilic segments, to hydrophilize the surface of hydrophobic fibres, such as polyester and nylon, and hydrophobic segments, to deposit upon hydrophobic fibres and remain adhered thereto through completion of washing and rinsing cycles and, thus, serve as an anchor for the hydrophilic segments. This can enable stains occurring subsequent to treatment with the soil release agent to be more easily cleaned in later washing procedures.

The polymeric soil release agents useful herein especially include those soil release agents having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least 25% oxyethylene units and more preferably, especially for such components having about 20 to 30 oxypropylene units, at least 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate: C₃ oxyalkylene terephthalate units is 2:1 or lower, (ii) C₄-C₆ alkylene or oxy C₄-C₆ alkylene segments, or mixtures therein, (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a)(i) will have a degree of polymerization of from 1 to 200, although higher levels can be used, preferably from 3 to 150, more preferably from 6 to 100. Suitable oxy C₄-C₆ alkylene hydrophobe segments include, but are not limited to, end-caps of polymeric soil release agents such as MO₃S(CH₂)ₙOCH₂CH₂O—, where M is sodium and n is an integer from 4-6, as disclosed in U.S. Pat. No. 4,721,580, issued Jan. 26, 1988 to Gosselink.

Polymeric soil release agents useful in the present invention also include cellulosic derivatives such as hydroxyether cellulosic polymers, co-polymeric blocks of ethylene terephthalate or propylene terephthalate with polyethylene oxide or polypropylene oxide terephthalate, and the like. Such agents are commercially available and include hydroxyethers of cellulose such as METHOCEL (Dow). Cellulosic soil release agents for use herein also include those selected from the group consisting of C₁-C₄ alkyl and C₄ hydroxyalkyl cellulose; see U.S. Pat. No. 4,000,093, issued Dec. 28, 1976 to Nicol, et al.

Soil release agents characterised by poly(vinyl ester) hydrophobe segments include graft co-polymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).

One type of preferred soil release agent is a co-polymer having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

Another preferred polymeric soil release agent is a polyester with repeat units of ethylene terephthalate units which contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126 (from Dupont) and MILEASE T (from ICI). See also U.S. Pat. No. 4,702,857, issued Oct. 27, 1987 to Gosselink.

Another preferred polymeric soil release agent is a sulfonated product of a substantially linear ester oligomer comprised of an oligomeric ester backbone of terephthaloyl and oxyalkyleneoxy repeat units and terminal moieties covalently attached to the backbone. These soil release agents are fully described in U.S. Pat. No. 4,968,451, issued Nov. 6, 1990 to J. J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred polymeric soil release agents also include the soil release agents of U.S. Pat. No. 4,877,896, issued Oct. 31, 1989 to Maldonado et al, which discloses anionic, especially sulfoaroyl, end-capped terephthalate esters.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof. See U.S. Pat. No. 5,415,807, issued May 16, 1995, to Gosselink et al.

If utilised, soil release agents will generally comprise from 0.01% to 10.0%, by weight, of the detergent compositions herein, typically from 0.1% to 5%, preferably from 0.2% to 3.0%.

In an another embodiment of the present invention, it is provided a kit of parts comprising: (a) a laundry pretreater composition comprising a peroxycarboxylic acid; (b) instructions for treating fabrics according to the process herein, and optionally, (c) an implement suitable for use in the process according to the present invention.

Packaging Form of the Kit of Parts of the Present Invention:

Depending on the end-use envisioned, the laundry pretreater composition herein can be packaged in a variety of containers including conventional bottles.

In one embodiment of the present invention the composition is packaged in a two compartment container, wherein the laundry pretreater composition as described herein is packaged in one compartment and a second composition is packaged in the second compartment. In a particularly preferred aspect of the present invention, the second composition is a conventional heady duty liquid detergent composition, preferably comprising ingredients, particularly bleach-sensitive ingredients such as surfactants, enzymes and perfumes.

Instructions for treating fabrics according to the process herein may be printed directly onto the exterior surface of the container or on a separate sheet of paper.

The instructions may be included in any manner typically used by consumer products manufacturing or supply companies. Examples include providing instructions on a label attached to the container holding the composition; on a sheet either attached to the container or accompanying it when purchased; or in advertisements, demonstrations, and/or other written or oral instructions which may be connected to the purchase or use of the compositions. Specifically, the instructions will include a description of the use of the composition, for instance, the recommended amount of composition to use in a washing machine to clean the fabric; the recommended amount of compositions to apply to the fabric; if soaking or rubbing is appropriate.

The kit of parts according to the present invention may optionally comprise an implement suitable for use in the process herein. In a preferred execution, the implement is removably attached to the container. In an alternative execution, the implement is built into the container.

Suitable implements are for instance brushes, wipes, sponges. In a highly preferred execution of the invention, the implement is selected to be a brush. Preferably for use in the process according to the present invention, the implement is made from a material which is not capable of absorbing the laundry pretreater composition.

For more convenience, the implement may be advantageously combined with a handle attached to it by means of adhesive, glue or by heat sealing. Preferably, the implement may be attached to a stick made of wood, plastic or metal.

In a very preferred execution, the kit of parts herein is in a form of a portable packaging comprising (a) a container comprising the laundry pretreater composition and optionally a conventional laundry detergent composition, (b) instructions for treating fabrics according to the process herein and (c) an implement suitable for use in the process according to the present invention.

### Test Method

Stain Removal Performance Test

Stain Removal Performances obtained on soiled fabric when using a process of treating fabric according to the present invention, are calculated by using standard Image Analysis Technique. More specifically, the Stain Removal Performance is evaluated by measuring the Color Deviation (□E) of the washed stain versus the unwashed stain using a Color Measurement Instrument. The Performance Results are expressed as SRI% (i.e. Stain Removal Index) which represents the percentage of removed stain versus reference unwashed. Compositions giving the greater SRI% represent compositions leading to the better Stain Removal Performance upon washing.

A suitable protocol for assessing the Stain Removal Performance is the following:

Equipment needed: Technical stain sets available from Warwick Equest Limited and made of a white cotton sheet (20 cm×15 cm) on which 16 standard circular stains are applied; a Hotpoint Aquarius 1200 washing machine; a regular Miele Tumble dryer; a color (RGB) video camera supplied by Sony and used as the Color Measurement Instrument; regular irradiating lamps; a regular Personal Computer coupled with an Image Analysis Software (Optimas®, available from Media Cybernetics).

Preparation of the Test: The above technical stains are treated by pouring 2 g of pretreating composition on each stain of the same technical set. Thereafter, the treated stains are brushed 10 times in a left-to-right-to-left motion using a plastic-made circular brush having a diameter of 2.5 cm, a height of 1 cm and provided with a handle. The resulting treated stain set is loaded into the Hotpoint Aquarius 1200 washing machine and washed at 40° C. with ˜110 g of Dash powder® detergent composition with city water, under short wash cycle (˜80 minutes). At the end of the wash cycle, the resulting washed stains are dried in the Miele Tumble dryer.

Stain Removal Performance Assessment: The above-described Image Analysis Equipment calculates the Color Deviation (□E) of the washed stain versus the unwashed stain, and extrapolates the SRI%. The Image Analysing System is able to statistically compute data from several replicates and calculates the significancy.

### EXAMPLES

The following compositions will further illustrate the present invention. The compositions are made by combining the listed ingredients in the listed proportions (weight % unless otherwise specified). Example compositions 1 to 4 are meant to exemplify compositions suitable for use in the process of the present invention but are not necessarily used to limit or otherwise define the scope of the present invention. Example composition A is a comparative example.

| | Compositions (% weight) | | | | |
|---|---|---|---|---|---|
| | 1 | 2 | 3 | 4 | A |
| PAP | 3.0 | 5.0 | 1.0 | 2.0 | — |
| Hydrogen peroxide | — | — | — | — | 3.0 |
| Hydroxyethanediphosphonate | 0.2 | 0.1 | 1.0 | 0.5 | 0.2 |
| Citric acid | — | 5.0 | — | 1.0 | — |
| Sodium octyl sulfonate | — | — | 1.0 | — | — |
| Sodium cumene sulfonate | — | — | — | 0.5 | — |
| Kelzan T | 0.6 | 0.3 | 0.5 | 0.4 | 0.6 |
| Alkanizing/acidizing agent up to pH | 3.5 | 2.5 | 3.0 | 2.0 | 3.5 |

HEDP is ethane 1-hydroxy diphosphonate commercially available from Monsanto under the serie Dequest®.

PAP is phthalimidoperoxyhexanoic acid available from Ausimont under the tradename Euroco®.

Kelzan T® is thickening and suspending Xanthan gum polymer available from CP Kelco.

Sodium octyl sulfonate is commercially available from Witco under the tradename Witconate® NAS-8.

Sodium cumene sulfonate is commercially available from Huntsman under the tradename Eltesol® SC40.

Compositions 1 to 4 when used in a process according to the present invention provide excellent bleaching performance as well as effective stain removal performance while being safe to the fabrics and colors.

### Comparative Data

The following examples will further illustrate the present invention. The compositions are made by combining the listed ingredients in the listed proportions (weight % unless otherwise specified). Example composition 1 is meant to exemplify compositions for use in the process of the present invention whereas example composition A is a comparative example.

Compositions
(% weight)

| | 1 | A |
|---|---|---|
| PAP | 3.0 | — |
| Hydrogen peroxide | — | 3.0 |
| Hydroxyethanediphosphonate | 0.2 | 0.2 |
| Kelzan T | 0.6 | 0.6 |
| Alkanizing/acidizing agent up to pH | 3.5 | 3.5 |

The following table presents comparative Stain Removal Performance results obtained on various stain types with a laundry pretreater composition 1 (comprising a peroxycarboxylic acid) versus a similar composition A comprising a regular hydrogen peroxide (comparative composition A is not suitable for use in the present invention).

| | Compo A | | Compo A + | Compo 1 | | Compo 1 + |
|---|---|---|---|---|---|---|
| Product | no brush | | brush | no brush | | brush |
| Stain type | SRI % | | SRI % | SRI % | | SRI % |
| Coffee | 81.0 | ns | 79.5 | 84.8 | s | 87.9 |
| Tea | 77.7 | ns | 76.1 | 84.4 | s | 88.4 |
| Wine | 75.4 | ns | 71.7 | 81.3 | s | 85.3 |
| Burnt butter | 85.2 | ns | 85.3 | 86.6 | s | 89.4 |
| Bacon grease | 88.3 | ns | 88.9 | 90.3 | s | 92.3 |

The above results clearly show the improved stain removal performance obtained while using a process according to the present invention, i.e. comprising the step of mechanically rubbing the laundry pretreater composition 1 into stained parts of the treated fabric, as compared to the performance delivered with a similar process but without the additional mechanical rubbing step.

The results also show that when comparing the cleaning performance of a regular peroxide-based pretreater composition with a similar peroxycarboxylic acid-based pretreater, both tested with and without brushing, a significantly improved cleaning performance on mixed greasy/bleachable stains (burnt butter, bacon grease) is observed for the peroxycarboxylic acid-containing pretreater composition applied using the implement, whereas the peroxide-based pretreater only shows an insignificant improvement. In addition, the cleaning performance on hydrophilic bleachable stains (coffee, teat, wine) by the peroxycarboxylic acid-containing pretreater composition is also improved due to the mechanical rubbing and when compared to the peroxide-based pretreater composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of treating a fabric comprising the successive steps of:
(a) applying a laundry pretreater composition comprising a peroxycarboxylic acid onto stained parts of a fabric; thereafter
(b) mechanically rubbing said composition into said stained parts of said fabric; and subsequently
(c) rinsing said fabric in an aqueous bath and/or washing said fabric in an aqueous wash liquor comprising water and a conventional laundry detergent.

2. A process according to claim 1 wherein said peroxycarboxylic acid is solid and substantially water-insoluble.

3. A process according to claim 1 wherein the peroxycarboxylic acid has general formula: 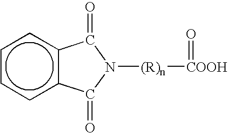
wherein R is C₁-C₄ alkyl and n is an integer of from 1 to 5.

4. A process according to claim 3 wherein the peroxycarboxylic acid has the formula wherein R is CH₂ and n is 5.

5. A process according to claim 1 wherein said mechanical rubbing allows said peroxycarboxylic acid to penetrate into said fabric.

6. A process according to claim 1 wherein said mechanical rubbing is performed using an implement.

7. A process according to claim 1 wherein said mechanical rubbing is performed using a brush.

8. A process according to claim 6 wherein said implement is made of a material which does not absorb said composition.

9. A process according to claim 6, wherein said implement is made from a synthetic material.

10. A process according to claim 1 wherein said mechanical rubbing is performed by rubbing said implement in a circular motion or in a back and forth transversal motion.

11. A process according to claim 1 wherein said laundry pretreater composition has pH of from 1 to 6.5.

12. A process according to claim 1 wherein said laundry pretreater composition comprises surfactant at a level of less than 5% by weight of the composition.

13. A process according to claim 1 wherein said laundry pretreater composition further comprises at least one suspending agent.

14. A process according to claim 1 wherein said laundry pretreater composition further comprises at least one polymer.

15. A process according claim 1 wherein said laundry pretreater composition is a liquid composition.

16. A process according to claim 15 wherein said laundry pretreater composition is in pasty form and has a viscosity of from 200 cps to 10000 cps, at 20 sec−1 and 20° C., when measured with a Carry-Med Rheometer model CSL2 100®.

17. A process according to claim 15 wherein said laundry pretreater composition is in pasty form and has a viscosity of from 500 to 5000 cps, at 20 sec−1 and 20° C., when measured with a Carry-Med Rheometer model CSL2 100®.

18. A process according to claim 15 wherein said laundry pretreater composition is in pasty form and has a viscosity of from 1000 to 3000 cps, at 20 sec−1 and 20° C., when measured with a Carry-Med Rheometer model CSL2 100®.

19. A process according to claim 15 wherein said laundry pretreater composition is in pasty form and has a viscosity of from 1000 to 2000 cps, at 20 sec−1 and 20° C., when measured with a Carry-Med Rheometer model CSL2 100®.

20. A process according to claim 1 performed in a laundry washing machine having at least one rinse cycle and a wash cycle.

21. A process according to claim 20 wherein step (c) is performed in least one rinse cycle and/or main wash cycle of the washing machine.

22. A kit comprising:
a) a laundry pretreater composition comprising a peroxycarboxylic acid,
b) instructions for treating a fabric according to the process of claim 1, and optionally,
c) an implement suitable for use in the process of any of the preceding claims.
